(19) United States
(12) Patent Application Publication
(10) Pub. No.: US 2022/0058483 A1
(43) Pub. Date: Feb. 24, 2022

(54) PARALLEL AND MULTI-LAYER LONG SHORT-TERM MEMORY NEURAL NETWORK ARCHITECTURES

(71) Applicant: AllocateRite, LLC, New York, NY (US)

(72) Inventors: Alex Liu, New York, NY (US); Michael Spece, New York, NY (US); Abbas Shah, New York, NY (US)

(21) Appl. No.: 17/405,084

(22) Filed: Aug. 18, 2021

Related U.S. Application Data
(60) Provisional application No. 63/067,520, filed on Aug. 19, 2020.

(51) Int. Cl. G06N 3/08; G06N 3/04

(52) U.S. Cl. CPC G06N 3/08; G06N 3/0454

(57) ABSTRACT

A parallel and multi-layer long short-term memory neural network architecture is disclosed. An example embodiment is configured to provide risk management models including parallel LSTM models and multi-layer LSTM models.

### CROSS-REFERENCE TO RELATED APPLICATIONS

This application claims the benefit of the filling date of U.S. Provisional Application Ser. No. 63/067,520 titled “PARALLEL AND MULTI-LAYER SHORT-TERM MEMORY NEURAL NETWORK ARCHITECTURES” and filed Aug. 19, 2020, and the subject matter of which is incorporated herein by reference.

### COPYRIGHT NOTICE

A portion of the disclosure of this patent document contains material that is subject to copyright protection. The copyright owner has no objection to the facsimile reproduction by anyone of the patent document or the patent disclosure, as it appears in the U.S. Patent and Trademark Office patent files or records, but otherwise reserves all copyright rights whatsoever. The following notice applies to the disclosure herein and to the drawings that form a part of this document: Copyright 2019-2020, AllocateRite, LLC, All Rights Reserved.

### TECHNICAL FIELD

This patent document pertains generally to data processing, deep learning, machine learning and artificial intelligence (AI) systems, neural networks, data communication networks, risk management, asset portfolio analysis and forecasting, and more particularly, but not by way of limitation, to a system and method for intelligent machine learning optimization to operate on large volumes of dynamic content using parallel and multi-layer long short-term memory neural network architectures.

### BACKGROUND

Machine learning and artificial intelligence (AI) systems are becoming increasingly popular and useful for processing data and augmenting or automating human decision making in a variety of applications. For example, images and image analysis are increasingly being used for autonomous vehicle control and simulation, among many other uses. Statistical data and financial data are types of input that can be used to train an AI system to identify patterns and trends. However, AI systems have been inadequately used in the conventional technologies for effectively managing asset portfolios and assessing risk. As a result, conventional systems have been unable to harness the power of AI to efficiently manage investments. As the investment opportunity landscape continually changes, there is a greater need for new dynamic approaches that leverage innovations in asset portfolio design and risk management for small investors and for the larger institutions and hedge funds.

Time series forecasting is an important area of machine learning that is often neglected. It is important because there are so many forecast and prediction problems that involve a time component. These problems are neglected because this time component makes time series problems more difficult to handle. Long Short-Term Memory networks, or LSTMs, can be applied to time series forecasting. There are many types of LSTM models that can be used for each specific type of time series forecasting problem. LSTM techniques can capture the relations within sub-sequences of time steps in sequential data. However, the use of LSTMs in conventional systems has been unable to produce robust and efficient tools for time series analysis and forecasting, particularly for the analysis and forecasting of financial data.

### BRIEF DESCRIPTION OF THE DRAWINGS

The various embodiments are illustrated by way of example, and not by way of limitation, in the figures of the accompanying drawings in which:

FIG. 1 illustrates an example embodiment of a risk management parallel LSTM model;

FIG. 2 illustrates an example embodiment of a multi-layer Convolutional Neural Network (CNN) LSTM model; and

FIGS. 3 and 4 are process flow diagrams illustrating example embodiments of systems and methods for implementing parallel and multi-layer long short-term memory neural network architectures.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

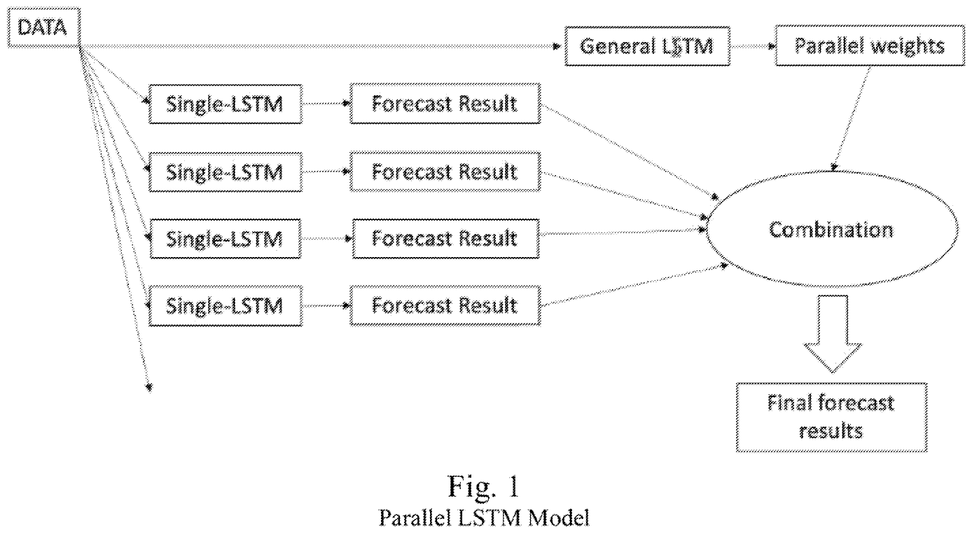

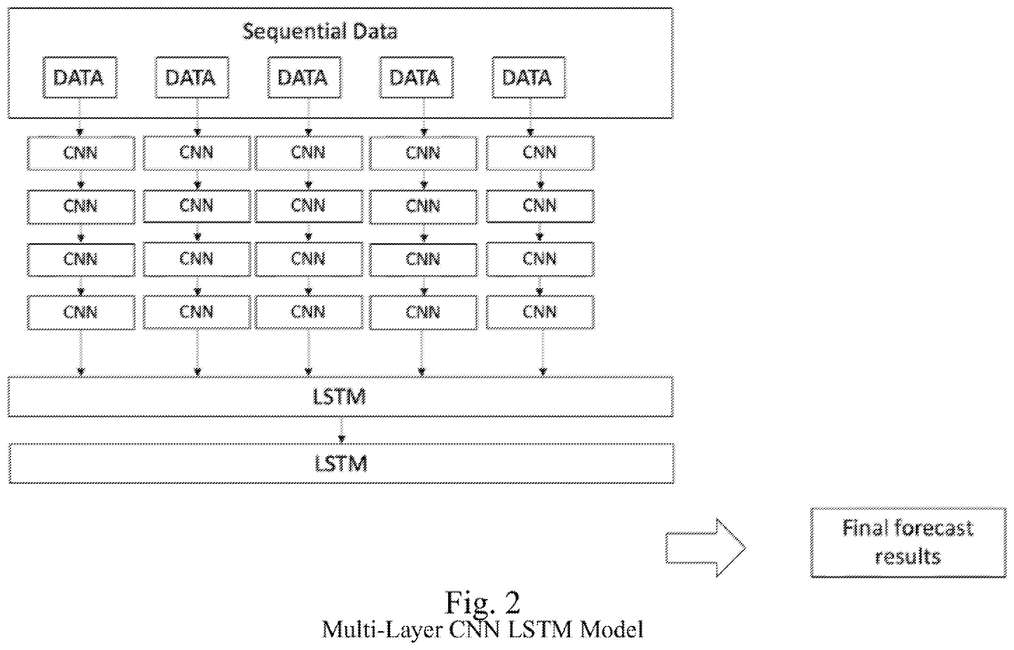

A parallel and multi-layer long short-term memory neural network architecture are disclosed. In the various example embodiments disclosed herein, a parallel and multi-layer long short-term memory neural network architecture can be implemented to facilitate automation of an investment strategy that is designed to realize optimized returns over longer term time horizons. This is accomplished by utilizing a new risk based approach to investing. Through dynamic diversification combined with real time rebalancing across different sectors and asset classes, users of a system implementing a parallel and multi-layer long short-term memory neural network architecture can over time achieve higher returns than most other broad market benchmarks. An important feature of the disclosed embodiments is to avoid market disruptions and offset and hedge risk, where possible. The parallel and multi-layer long short-term memory neural network architecture enables implementation of a highly sophisticated Asset Allocation Model. The Asset Allocation Model evaluates fundamental and technical information and then runs this information through various workflows, processes, and statistical techniques as disclosed herein. A primary goal is to identify the low risk sectors while balancing overall exposures across equities, fixed income, and cash. Consequently, the asset portfolio attributes include diversification, high liquidity, low overall costs, and potential tax advantages. FIGS. 1 and 2 illustrate example embodiments of the parallel and multi-layer long short-term memory neural network architecture as described herein for performing risk management and financial data analysis.

### Risk Management Models—Parallel LSTM Models

Referring to FIG. 1, LSTM (Long Short-Term Memory) has proven to be effective in analyzing time series/sequential data among many of the deep neural network techniques. However, conventional LSTM solutions face the challenges of lacking training data and losing features after being applied to the analysis of financial data. In order to solve this problem, the new model called a Parallel-LSTM model is disclosed herein. This new model has the ability to catch common features within an undetected group of securities or other feature domains.

Referring still to FIG. 1, in the stage of training the Parallel-LSTM model, we not only let the model learn the features and performance of all the stocks (or other asset classes), but also let the model learn the similarities of behaviors among all the stocks, so that the model has the ability to forecast a particular stock by analyzing some other similar stocks. The principle is similar to the squeeze and excitation concept for CNNs.

As shown in FIG. 1, the Parallel-LSTM model includes a General LSTM serving as an Administration LSTM. Additionally, the model includes a plurality of single LSTMs operating in parallel, each single LSTM processing an input data set and producing a forecast result. The General LSTM can use a set of parallel weights to evaluate the forecast results from each of the single LSTMs. This weighting or evaluation of the result of each single LSTM enables the assignment of a level of importance to each result of each single LSTM. The weighted results from the single LSTMs are aggregated by a combiner in a combination process to produce a final forecast result that represents the aggregate weighted outputs from each of the plurality of single LSTMs. This Parallel-LSTM model provides parallelism in the processing performed by the single LSTMs and ensemble curation of the multiple outputs from the single LSTMs.

In various applications, the Parallel-LSTM model can be used in financial data analysis and forecasting, tax forecasting and optimization, natural language processing, sound or music analysis and recommendation, or in other time series data analysis applications. Additionally, the Parallel-LSTM model can train in parallel with different users and combine inputs from the various users. Different LSTMs can be swapped for others to broaden the scope of the data analysis. The single LSTMs can learn from the other LSTMs and produce more useful combinations. In effect, the Parallel-LSTM model can be a learning model for combining results. The Parallel-LSTM model is a learning model using a different aggregation of process and data. Aggregate data from more than one single LSTM can be produced by the Parallel-LSTM model.

### Risk Management Models—Multi-Layer LSTM Models

Referring to FIG. 2, a multi-layer Convolutional Neural Network (CNN) LSTM model of an example embodiment is illustrated. The model can accept time series or sequential data sets of a pre-determined time period (e.g., each day). The data sets can each represent groupings of data related to a domain of a particular application. For an example in an investment application, the data sets can represent various features of the domain, such as prices, returns, volatilities, volume, and the like for various asset classes (e.g., stocks, ETFs, securities, options, commodities, bonds, and the like). Each data set can represent a snapshot or average of the values of the various features of the domain for a particular pre-determined time period (e.g., each day). The time series or sequential data sets can represent the values of the various features of the domain for successive increments of the pre-determined time period.

As shown in FIG. 2, each data set can be coupled to a plurality of CNNs in a series arrangement. The plurality of CNNs can accept a particular data set as input and process the data set to analyze and forecast the performance of the various features of the domain in the corresponding time period. For an example in an investment application, the plurality of CNNs can forecast statistics generation, market volatility, the Sharpe Ratio, and a variety of other indicators or market or investment trends for the corresponding time period. Most finance people understand how to calculate the Sharpe Ratio and what it represents. The Sharpe Ratio describes how much excess return an investor receives for the extra volatility the investor endures for holding a riskier asset. It is understood that the investor needs compensation for the additional risk the investor takes for not holding a risk-free asset. The bottom-line risk and reward must be evaluated together when considering investment choices; this is the focal point presented in Modern Portfolio Theory. In a common definition of risk, the standard deviation or variance takes rewards away from the investor. As such, the risk should be assessed along with the reward when choosing investments. The Sharpe Ratio can help the investor determine the investment choice that will deliver the highest returns while considering risk. In a particular example embodiment, each CNN of the plurality of CNNs can be a 9-layer standard 1D fully-connected convolutional neural network (CNN), which can be used to analyze and forecast features from the data sets.

Referring again to FIG. 2, each data set of the time series group of data sets can be coupled to its own plurality of CNNs arranged in series. This structure enables each of the plurality of CNNs to operate in parallel on data sets corresponding to different time periods. This enables each of the plurality of CNNs to perform analysis and forecasting on data corresponding to different sequential time periods.

Referring still to FIG. 2, the output of each of the plurality of CNNs in series can be provided as input to one or more LSTMs. The LSTMs can be used to analyze the time series nature of the features analyzed and forecast from the CNN stage (e.g., each of the plurality of CNNs). This structure allows the model to obtain the non-linear relationships among sub-sequentials among the input series. In various example embodiments, different machine learning models can be implemented for different forecasting goals. For example, a particular embodiment can use the CNN-LSTM model disclosed herein to forecast the correlation between asset portfolios and benchmarks. The fully connected CNN stage (e.g., each of the plurality of CNNs) can be used to analyze the relationship among all features (e.g., price, return, volatility, volume, and the like) on each single day, and the LSTMs can be used to analyze the time series nature of the asset portfolio and market features that are obtained from the CNN stage.

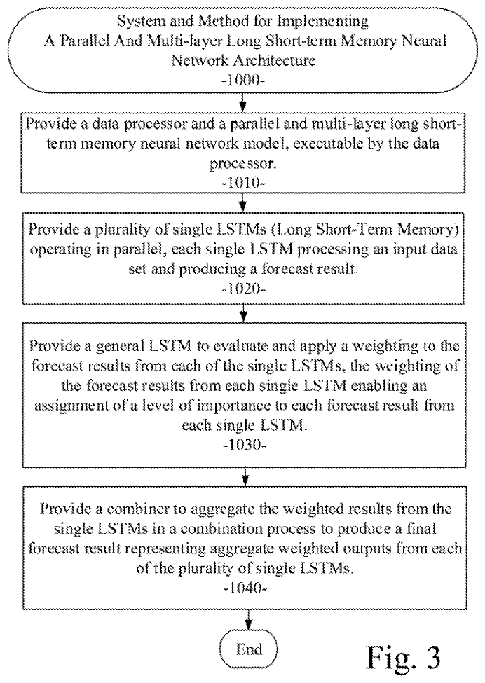

Referring now to FIG. 3, a flow diagram illustrates an example embodiment of a system and method 1000 providing a parallel and multi-layer long short-term memory neural network architecture. The example embodiment can be configured to provide: a data processor and a parallel and multi-layer long short-term memory neural network model, executable by the data processor (block 1010); a plurality of single LSTMs (Long Short-Term Memory) operating in parallel, each single LSTM processing an input data set and producing a forecast result (block 1020); a general LSTM to evaluate and apply a weighting to the forecast results from each of the single LSTMs, the weighting of the forecast results from each single LSTM enabling an assignment of a level of importance to each forecast result from each single LSTM (block 1030); and a combiner to aggregate the weighted results from the single LSTMs in a combination process to produce a final forecast result representing aggregate weighted outputs from each of the plurality of single LSTMs (block 1040).

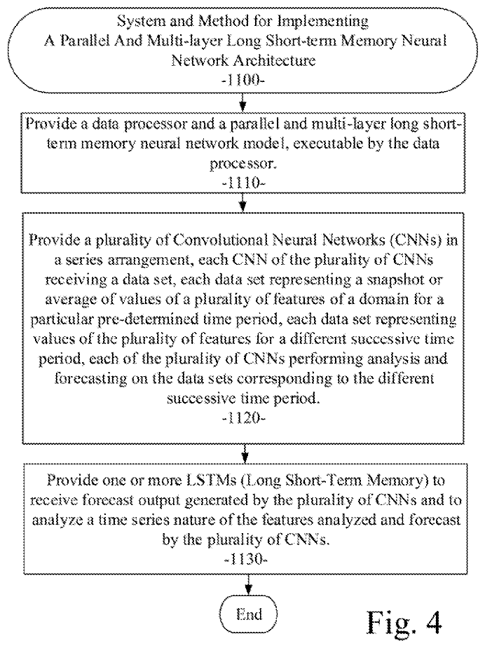

Referring now to FIG. 4, a flow diagram illustrates an example embodiment of a system and method 1100 providing a parallel and multi-layer long short-term memory neural network architecture. The example embodiment can be configured to provide: a data processor and a parallel and multi-layer long short-term memory neural network model, executable by the data processor (block 1110); a plurality of Convolutional Neural Networks (CNNs) in a series arrangement, each CNN of the plurality of CNNs receiving a data set, each data set representing a snapshot or average of values of a plurality of features of a domain for a particular pre-determined time period, each data set representing values of the plurality of features for a different successive time period, each of the plurality of CNNs performing analysis and forecasting on the data sets corresponding to the different successive time period (block 1120); and one or more LSTMs (Long Short-Term Memory) to receive forecast output generated by the plurality of CNNs and to analyze a time series nature of the features analyzed and forecast by the plurality of CNNs (block 1130).

Glossary of Terms

| Term | Definition |
|---|---|
| Artificial Intelligence | Is conventionally, if loosely, defined as intelligence exhibited by |
| (AI) | machines. |
| Allocation | AllocateRite's terminology used to incorporate the generation of |
| | proposed buy-sell signals/trades of individual securities by its |
| | dynamic algorithmic model to properly rebalance portfolios |
| Broker | Financial Institutions that buys and sells securities (executing |
| | broker) and/or holds custody of financial assets (custodian broker). |
| Composite | An aggregation of one or more portfolios managed according to |
| | a similar investment mandate, objective, or strategy and is the |
| | primary vehicle for presenting performance to prospective clients. |
| Current Value | The summation of quantity multiplied by price of all securities |
| | held within a portfolio on that same day. |
| Dynamic Asset | A portfolio management strategy that frequently adjusts the mix |
| Allocation | of asset classes to better manage risks in varying market conditions. |
| Equities | Common stocks (ordinary shares) traded in a securities market. |
| ETF | An exchange-traded fund (ETF) is a collection of securities you |
| | buy or sell through a brokerage firm on a stock exchange. ETFs |
| | are offered on virtually all asset classes ranging from traditional |
| | investments to alternative assets. |
| Financial Crisis | The crisis risk is essentially a max downside risk over a window |
| | of time that goes back to either the (i) Financial Crisis or (ii) |
| | earliest IPO among a portfolio's tickers, whichever is most recent |
| Fixed Income | Type of debt instrument that provides returns in the form of |
| | regular, or fixed, interest payments and repayments of the |
| | principal when the security reaches maturity. Instruments are |
| | issued by governments, corporations, and other entities to |
| | finance their operations |
| Global Macro Model | Based on global technical and/or fundamental analysis to |
| | directionally position a portfolio across a broad range of markets |
| | and/or asset classes. Fundamental factors evaluate opportunities |
| | based on criteria such as valuation metrics, economic forecasts, |
| | interest rate and currency outlooks, and fiscal and monetary |
| | policy. The information employed may be macro-economic or |
| | the aggregation of micro-level information. These managers tend |
| | to be close followers of academia, particularly econometrics. • |
| | Technical factors utilize predictive signals that are generated |
| | from market-related information (e.g., price, volume), and often |
| | involve the use of pattern recognition and other types of |
| | advanced statistical forecasting tools |
| Inception Date | Starting date of when capital was invested for a specific account |
| ITD | Inception to Date |
| Initial Capital | The starting investment monies contributed to a specific account |
| Liquidity | A high volume of activity in a financial marketplace/exchange |
| Long Only | Term used to identify portfolios that buy “long” positions in |
| | assets and securities. To be “long” an asset, derivative or security |
| | means being a buyer, generally one who benefits from an |
| | increase in prices |
| LTD | Life to Date |
| MTD | Month to Date |
| Re-balance | AllocateRite's terminology used to incorporate the generation of |
| | proposed buy-sell signals/trades/allocation percentages of |
| | individual securities for a portfolio or set of portfolios by its |
| | dynamic algorithmic model |
| Return/Performance | The quantification of total gains and losses over the account's |
| | equity for a designated time frame |
| Strategy | AllocateRite's terminology used to identify a subset within one |
| | of AllocateRite's Composites based on a set of characteristics |
| | that would constitute distinct portfolio group |
| YTD | Year to Date |
| Value | Shorthand for Market Value |
| AI Based Overall | A composite risk score based on the geometric average of the |
| Portfolio Risk Forecast | expected and crisis risks |
| Maximum Potential | Is the maximum potential loss of value a current portfolio could |
| Loss | incur under extreme conditions as calculated by AR AI risk forecaster |
| Drawdown (Potential | The maximum loss in the portfolio's value from peak to trough. |
| Loss) | This is an indicator of risk in a specific portfolio |
| Expected Risk | Also known as Expected Shortfall (ES) or Conditional Value at |
| | Risk (CVaR) is a statistic used to quantify the risk of a portfolio. |
| | Given a certain confidence level, this measure represents the |
| | expected loss when it is greater than the value of the VaR |
| | calculated with that confidence level. The Conditional Value-at- |
| | Risk (CVaR) is closely linked to VaR. It is simply the average of |
| | those values that fall beyond the expected VaR. This translates to |
| | the further potential of loss of an asset or portfolio. Riskier assets |
| | will exceed VaR by a more significant degree |
| Liquidity Risk | Risk that the organizing company or bank may be unable to meet |
| | short term financial demands. This usually occurs due to the |
| | inability to convert a security or hard asset to cash without a loss |
| | of capital and/or income in the process |
| Maximum Downside | Traditionally known as drawdown, the downside risk historically |
| Risk | measures the loss between portfolio highs and lows. The |
| | maximum of these measurements (over a given window of time) |
| | represents the risk from mistiming the market. In the |
| | RiskMonkey max downside risk plot, this window is |
| | approximately 2.5 years |
| Maximum Historical | The max loss suffered by the portfolio since 2007 with |
| Drawdown | historically monthly dynamic portfolio rebalancing. The |
| | portfolio was rebalanced monthly |
| Correlation with S&P | A number from 0 to 1 that reveals how closely a portfolio tracks |
| Forecast | the benchmark (S&P) |
| Risk | AllocateRite's calculation of potential risk of loss in a portfolio |
| | based on sophisticated dynamic computations using proprietary |
| | statistical and AI based modeling tools. AllocateRite calculates |
| | its own VaR and CVaR using this methodology |
| VaR | A measurement and quantification of the potential level of |
| | financial downside risk within a portfolio or position over a |
| | specific time frame. It is the possible loss in value assuming |
| | “normal market risk” as opposed to all risks. More specifically, it |
| | is the statistical probability of the loss, using a confidence |
| | interval, defining the probability distributions of individual risks, |
| | the correlation across these risks and the effect of such risks on |
| | the portfolio's value. For example, if an investor's 10-day 99% |
| | VAR is $10,000.00, there is considered to be only a 1% chance |
| | that losses will exceed $10,000.00 in 10 days |
| Correlation | Statistical measure of the degree to which the movements of two |
| | variables are related |
| Dispersion | A term used in statistics that refers to the location of a set of |
| | values relative to a mean or average level. In finance, dispersion |
| | is used to measure the volatility of different types of investment |
| | strategies. Returns that have wide dispersions are generally seen |
| | as more risky because they have a higher probability of closing |
| | dramatically lower than the mean. In practice, standard deviation |
| | is the tool that is generally used to measure the dispersion of |
| | returns |
| Fundamental Inputs | Use valuation techniques and macroeconomic variables as inputs |
| (basis for investment | to investment decisions |
| views) | |
| Overbought | An indicator that a given security's price has become abnormally |
| | high and, thereby, potentially expensive |
| Oversold | An indicator that a given security's price has become abnormally |
| | low and, thereby, potentially cheap |
| Momentum (MOM) | Indicates whether a given security's price has an upward (icon), |
| | downward (icon), or neutral (icon) trend, based on the recently |
| | observed acceleration of the stock's return. It is upward if the |
| | security has positive acceleration but is not overbought; |
| | downward if the given security has negative acceleration but is |
| | not oversold; and neutral otherwise. Note these trends only factor |
| | in price movements, not necessarily fundamental changes in |
| | either the market or the underlying assets of the security; such |
| | trends are said to be purely technical. As historical measures, |
| | they are subject to reversal at any time and are not recommendations |
| Stacking/Layering | An algorithm that takes the outputs of sub-models as input and |
| | attempts to learn how to best combine the input predictions to |
| | make a better output prediction. |
| Systematic Style | No human intervention in trade generation |
| (application of views) | |
| Technical Inputs (basis | Employ market-based (e.g., price and volume) information as |
| for investment views) | inputs to trading decisions |
| Volatility or VIX | A statistical measure of the tendency of a market or security to |
| | rise or fall sharply within a period of time-usually measured by |
| | standard deviation |

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A parallel and multi-layer long short-term memory neural network system, the system comprising:
a data processor; and
a parallel and multi-layer long short-term memory neural network model, executable by the data processor, the parallel and multi-layer long short-term memory neural network model including:
a plurality of single LSTMs (Long Short-Term Memory) operating in parallel, each single LSTM processing an input data set and producing a forecast result;
a general LSTM to evaluate and apply a weighting to the forecast results from each of the single LSTMs, the weighting of the forecast results from each single LSTM enabling an assignment of a level of importance to each forecast result from each single LSTM; and
a combiner to aggregate the weighted results from the single LSTMs in a combination process to produce a final forecast result representing aggregate weighted outputs from each of the plurality of single LSTMs.

2. A parallel and multi-layer long short-term memory neural network system, the system comprising:
a data processor; and
a parallel and multi-layer long short-term memory neural network model, executable by the data processor, the parallel and multi-layer long short-term memory neural network model including:
a plurality of Convolutional Neural Networks (CNNs) in a series arrangement, each CNN of the plurality of CNNs receiving a data set, each data set representing a snapshot or average of values of a plurality of features of a domain for a particular pre-determined time period, each data set representing values of the plurality of features for a different successive time period, each of the plurality of CNNs performing analysis and forecasting on the data sets corresponding to the different successive time period; and
one or more LSTMs (Long Short-Term Memory) to receive forecast output generated by the plurality of CNNs and to analyze a time series nature of the features analyzed and forecast by the plurality of CNNs.
